(19) United States
(12) Patent Application Publication
(10) Pub. No.: US 2014/0344418 A1
(43) Pub. Date: Nov. 20, 2014

(54) DYNAMIC CONFIGURATION ANALYSIS

(71) Applicant: Bank of America Corporation, Charlotte, NC (US)

(72) Inventors: Thomas C. Jones, Charlotte, NC (US); Martin Sannino, Coatesville, PA (US); Timothy M. Edwards, Charlotte, NC (US); Jerry Callison, Jacksonville, FL (US)

(73) Assignee: Bank of America Corporation, Charlotte, NC (US)

(21) Appl. No.: 13/896,851

(22) Filed: May 17, 2013

(51) Int. Cl. H04L 12/24

(52) U.S. Cl. CPC H04L 41/0803
USPC 709/220

(57) ABSTRACT

A plurality of configuration files may be received from a plurality of servers. Each configuration file of the plurality of configuration files may comprise a plurality of attribute types and a plurality of attribute values. Each of the plurality of attribute values may correspond to one or more of the plurality of attribute types. A dynamic benchmark configuration file may be generated. The dynamic benchmark configuration file may comprise each of the plurality of attribute types and a benchmark attribute value corresponding to each attribute type of the plurality of attribute types. The benchmark attribute value may comprise an attribute value equivalent to an attribute value of a majority of the plurality of attribute values that correspond to the attribute type.

### BACKGROUND

As computing devices and the applications they support increasingly pervade aspects of society, an ever complex infrastructure is developing to keep up with user demands. This infrastructure includes computing environments that can, and often, do include multiple servers for supporting common or similar applications. Such multi-server computing environments provide scalability, redundancy, and efficiency (e.g., by supporting geographic distribution, load balancing, and the like). Their utilization, however, often presents new challenges. For example, complex multi-server computing environments may rely on large volumes (e.g., thousands, tens of thousands, or more) of configuration files. Certain inconsistencies within these configuration files may make such multi-server computing environments vulnerable to one or more errors, degrade their performance, or the like. Due to their unwieldy volume, however, identifying such inconsistencies has become a daunting task. Accordingly, a need exists for dynamic configuration analysis.

### SUMMARY

The following presents a simplified summary in order to provide a basic understanding of some aspects of the disclosure. This summary is not an extensive overview of the disclosure. It is neither intended to identify key or critical elements of the disclosure nor to delineate the scope of the disclosure. The following summary merely presents some concepts of the disclosure in a simplified form as a prelude to the description below.

A plurality of configuration files may be received from a plurality of servers. Each configuration file of the plurality of configuration files may comprise a plurality of attribute types and a plurality of attribute values. Each of the plurality of attribute values may correspond to one or more of the plurality of attribute types. A dynamic benchmark configuration file may be generated. The dynamic benchmark configuration file may comprise each of the plurality of attribute types and a benchmark attribute value corresponding to each attribute type of the plurality of attribute types. The benchmark attribute value may comprise an attribute value equivalent to an attribute value of a majority of the plurality of attribute values that correspond to the attribute type.

In some embodiments, generating the dynamic benchmark configuration file may include comparing each configuration file of the plurality of configuration files to each other configuration file of the plurality of configuration files. Comparing each configuration file of the plurality of configuration files to each other configuration file of the plurality of configuration files may include, for each attribute type of the plurality of attribute types, comparing one or more attribute values of the plurality of attribute values of the configuration file that correspond to the attribute type to one or more attribute values of the plurality of attribute values of the other configuration file that correspond to the attribute type.

In some embodiments, each configuration file of the plurality of configuration files may be compared to the dynamic benchmark configuration file, and each attribute type of the configuration file having one or more attribute values that differ from one or more attribute values of a corresponding attribute type of the dynamic benchmark configuration file may be identified. Comparing each configuration file of the plurality of configuration files to the dynamic benchmark configuration file may include, for each attribute type of the plurality of attribute types, comparing one or more attribute values of the plurality of attribute values of the configuration file that correspond to the attribute type to one or more attribute values of the plurality of attribute values of the dynamic benchmark configuration file that correspond to the attribute type.

In some embodiments, prior to comparing each configuration file of the plurality of configuration files to the dynamic benchmark configuration file, a plurality of token attribute types of the plurality of attribute types may be identified. Each of the plurality of token attribute types may correspond to an attribute type of the plurality of attribute types whose corresponding attribute value is expected to differ from a corresponding attribute value of one or more other of the plurality of configuration files. For each identified token attribute type of the plurality of token attribute types, an attribute value corresponding to the token attribute type may be replaced with a common token attribute value for each of the plurality of configuration files. In such embodiments, comparing one or more attribute values of the plurality of attribute values of the configuration file that correspond to the attribute type to one or more attribute values of the plurality of attribute values of the dynamic benchmark configuration file that correspond to the attribute type may include, for each identified token attribute type of the plurality of token attribute types, comparing an attribute value of the configuration file comprising the common token attribute value to an attribute value of the dynamic benchmark configuration file comprising the common token attribute value.

In some embodiments, a user interface may be generated. The user interface may include a listing of one or more types of configuration files of at least a portion of the plurality of configuration files. The user interface may also include a listing of one or more computing environments. The user interface may further include, for each combination of a configuration file type listed within the listing of the one or more types of configuration files and an environment listed within the listing of the one or more computing environments, an indication of whether a plurality of configuration files of the configuration file type that correspond to one or more servers of the plurality of servers that are associated with the environment have one or more corresponding attribute types comprising differing attribute values. In such embodiments, responsive to a selection of a combination of a configuration file type listed within the listing of the one or more types of configuration files and an environment listed within the listing of the one or more computing environments, a second user interface may be generated. The second user interface may include a side-by-side comparison of at least one configuration file of the plurality of configuration files and the dynamic benchmark configuration file. The at least one configuration file and the dynamic configuration file may be of the configuration file type, and the at least one configuration file may correspond to the one or more servers of the plurality of servers that are associated with the environment.

In some embodiments, the side-by-side comparison of the at least one configuration file and the dynamic benchmark configuration file may include at least one visual indication of one or more corresponding attribute types comprising differing attribute values. Additionally or alternatively, the side-by-side comparison of the at least one configuration file and the dynamic benchmark configuration file may include at least one visual indication that a common token attribute value of the at least one configuration file was compared with a common token attribute value of the dynamic benchmark configuration file.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative operating environment for dynamic configuration analysis in accordance with one or more example embodiments;

FIG. 4 depicts an illustrative event sequence for dynamic configuration analysis in accordance with one or more example embodiments;

FIG. 5 depicts an illustrative configuration analysis report user interface (UI) for dynamic configuration analysis in accordance with one or more example embodiments;

FIG. 6. depicts an additional illustrative configuration analysis report UI for dynamic configuration analysis in accordance with one or more example embodiments; and

FIG. 7 depicts an illustrative method for dynamic configuration analysis in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

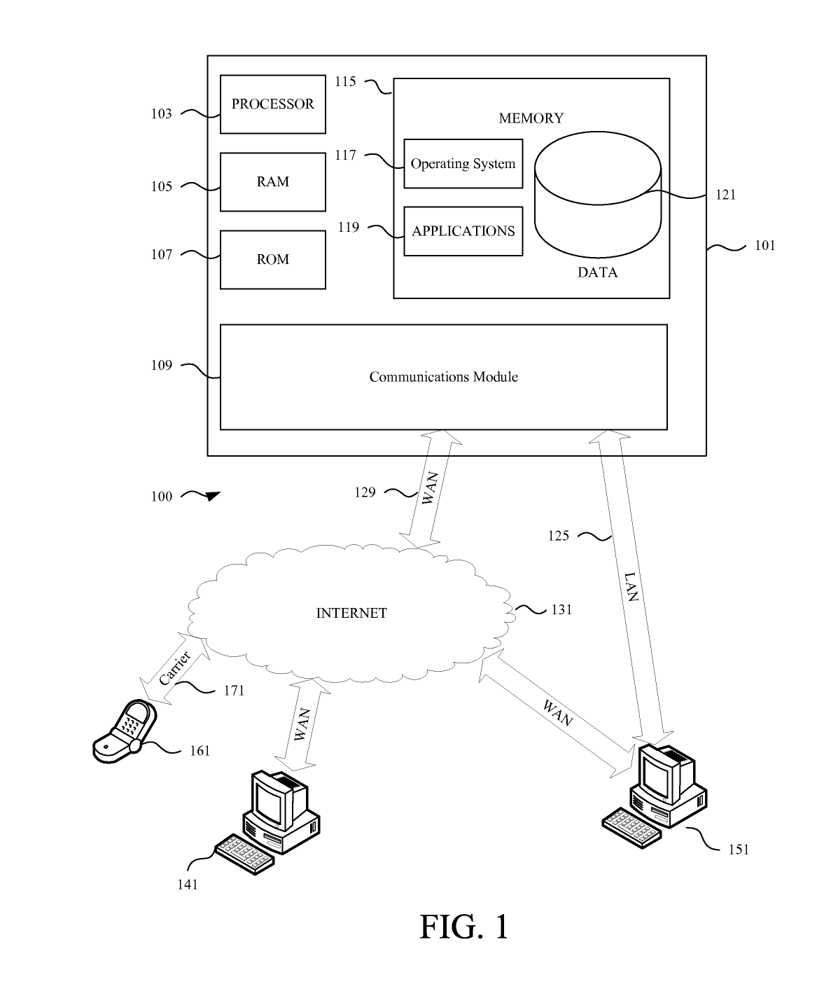

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

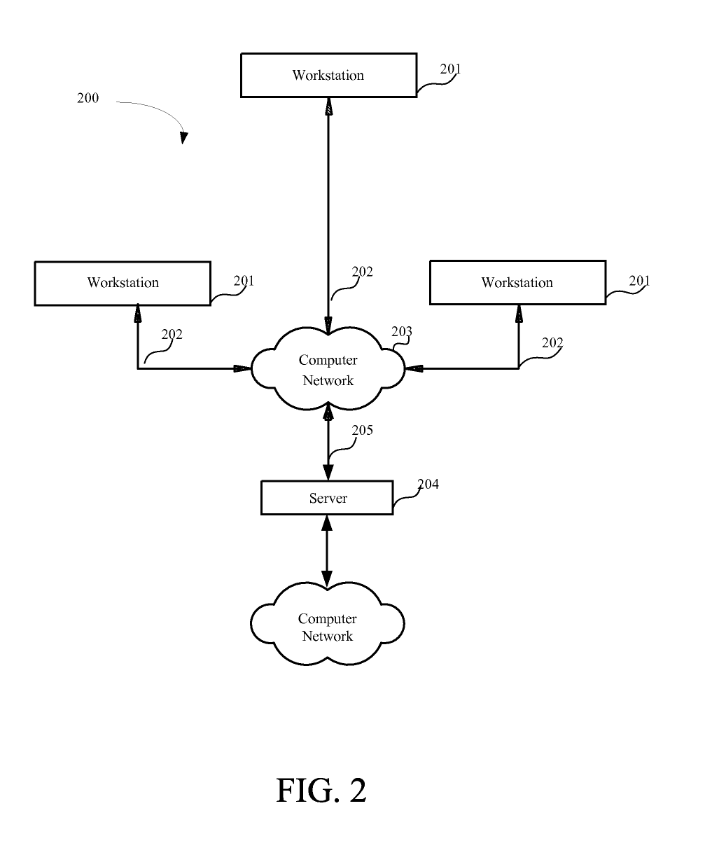

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

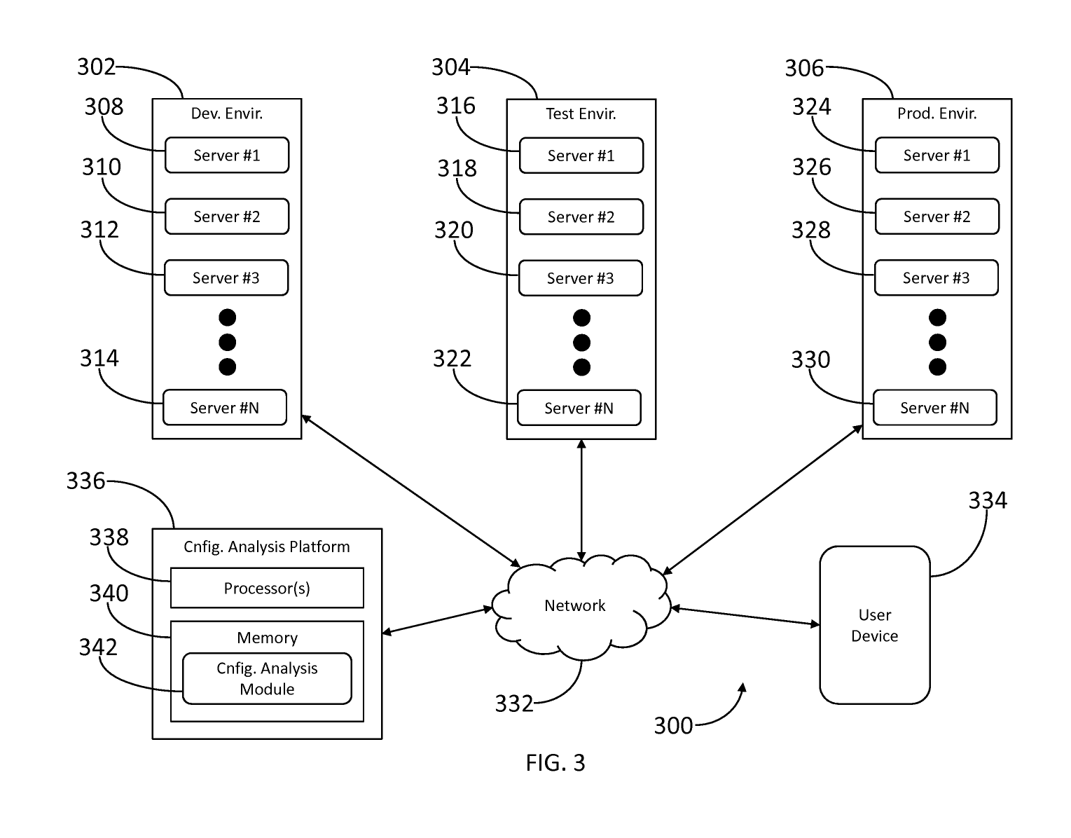

FIG. 3 depicts an illustrative operating environment for dynamic configuration analysis in accordance with one or more example embodiments. Referring to FIG. 3, operating environment 300 may include one or more computing environments. For example, operating environment 300 may include computing environments 302, 304, and 306. Computing environments 302, 304, and 306 may include one or more associated computing resources. For example, computing environment 302 may include servers 308, 310, 312, and 314, each of which may be part of a development computing environment. Similarly, computing environment 304 may include servers 316, 318, 320, and 322, each of which may be part of a test computing environment; and computing environment 306 may include servers 324, 326, 328, and 330, each of which may be part of a production computing environment. One or more of servers 308, 310, 312, 314, 316, 318, 320, 322, 324, 326, 328, and 330 may be any type of computing device that supports one or more applications (e.g., a mainframe, midrange, microcomputer, blade, virtual computer, or the like). As will be described in greater detail each of servers 308, 310, 312, 314, 316, 318, 320, 322, 324, 326, 328, and 330 may include one or more configuration files that affect one or more of its respective operations.

Operating environment 300 may also include one or more networks. For example, operating environment 300 may include network 332. Network 332 may include one or more sub-networks (e.g., LANs, WANs, or the like) and may interconnect one or more of computing environments 302, 304, and 306. Operating environment 300 may further include user device 334. User device 334 may be connected to network 332, and may be any type of computing device capable of presenting a user with information. For example, user device 334 may be a desktop computer, laptop computer, tablet computer, mobile device, or the like.

Operating environment 300 may further include configuration analysis platform 336. Configuration analysis platform 336 may include processor(s) 338 and memory 340. Memory 340 may include configuration analysis module 342. As will be described in greater detail below, configuration analysis module 342 may include one or more executable instructions that when executed by processor(s) 338 perform one or more functions described herein. For example, configuration analysis platform 336 may receive a plurality of configuration files from a plurality of servers (e.g., servers 308, 310, 312, 314, 316, 318, 320, 322, 324, 326, 328, and 330). Each configuration file of the plurality of configuration files may comprise a plurality of attribute types (e.g., “ServerRoot,” “PidFile,” “Timeout,” “KeepAlive,” “MaxKeepAliveRequests,” and the like) and a plurality of attribute values (e.g., “/host/configs/Server$123,” “host/logs/$456/httpd.pid,” “300,” “On,” “500,” and the like). Each of the plurality of attribute values may correspond to one or more of the plurality of attribute types (e.g., “ServerRoot” may correspond to “/host/configs/Server$123,” “PidFile” may correspond to “host/logs/$456/httpd.pid,” “Timeout” may correspond to “300,” “KeepAlive” may correspond to “On,” “MaxKeepAliveRequests” may correspond to “500,” and the like). A dynamic benchmark configuration file may be generated. The dynamic benchmark configuration file may comprise each of the plurality of attribute types (e.g., “ServerRoot,” “PidFile,” “Timeout,” “KeepAlive,” “MaxKeepAliveRequests,” and the like) and a benchmark attribute value corresponding to each attribute type of the plurality of attribute types (e.g., “/host/configs/Server$123,” “host/logs/$456/httpd.pid,” “300,” “On,” “500,” and the like). The benchmark attribute value may comprise an attribute value equivalent to an attribute value of a majority of the plurality of attribute values that correspond to the attribute type (e.g., “/host/configs/Server$123,” “host/logs/$456/httpd.pid,” “300,” “On,” “500,” and the like may be associated with their respective attribute types for a majority of the configuration files received from servers 308, 310, 312, 314, 316, 318, 320, 322, 324, 326, 328, and 330, or one or more identified portions thereof (e.g., servers 308, 310, 312, and 314, associated with computing environment 302; servers 316, 318, 320, and 322, associated with computing environment 304; and/or servers 324, 326, 328, and 330, associated with computing environment 306)).

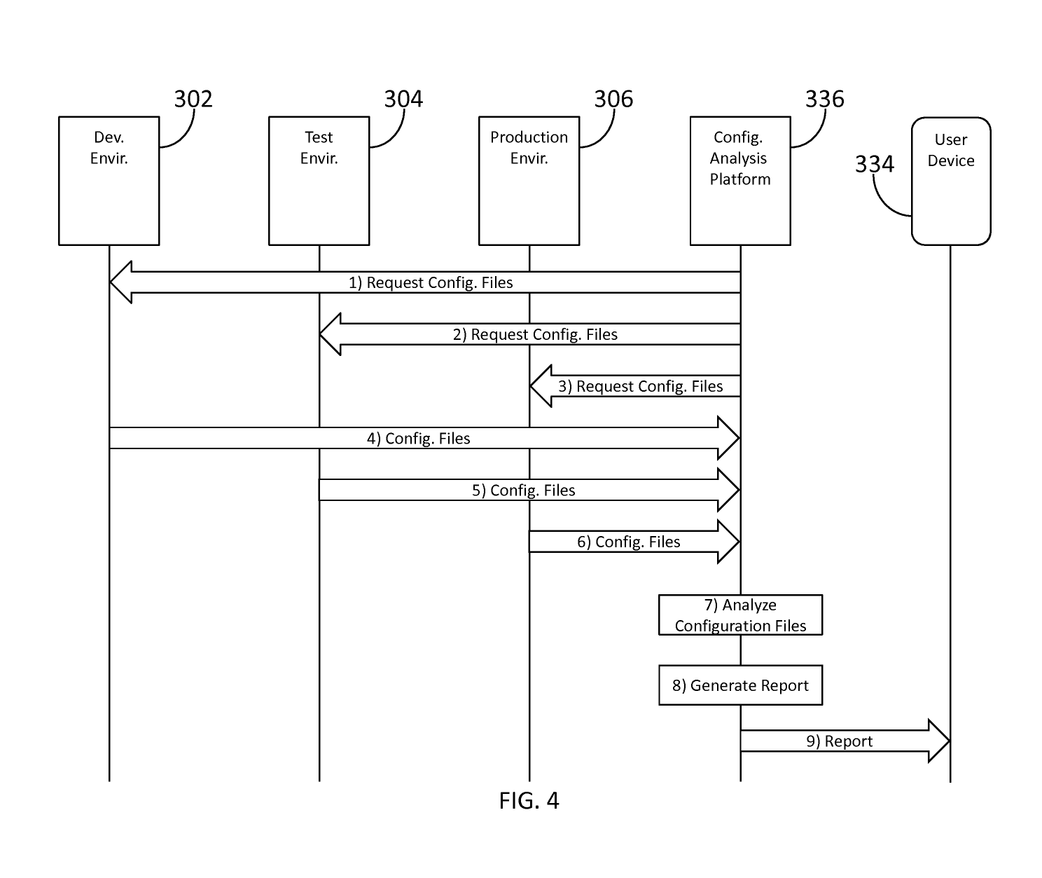

FIG. 4 depicts an illustrative event sequence for dynamic configuration analysis in accordance with one or more example embodiments. Referring to FIG. 4, at step 1, configuration analysis platform 336 may request (e.g., “poll”) one or more configuration files from computing environment 302 (e.g., from one or more of servers 308, 310, 312, and 314). At step 2, configuration analysis platform 336 may request one or more configuration files from computing environment 304 (e.g., from one or more of servers 316, 318, 320, and 322). At step 3, configuration analysis platform 336 may request one or more configuration files from computing environment 306 (e.g., from one or more of servers 324, 326, 328, and 330). At step 4, configuration analysis platform 336 may receive the one or more requested configuration files from computing environment 302 (e.g., from one or more of servers 308, 310, 312, and 314). At step 5, configuration analysis platform 336 may receive the one or more requested configuration files from computing environment 304 (e.g., from one or more of servers 316, 318, 320, and 322). At step 6, configuration analysis platform 336 may receive the one or more requested configuration files from computing environment 306 (e.g., from one or more of servers 324, 326, 328, and 330). It will be appreciated that the one of more configuration files received from computing environments 302, 304, and/or 306 need not be polled. For example, one or more of servers 308, 310, 312, 314, 316, 318, 320, 322, 324, 326, 328, and/or 330 may configured to send (e.g., “push”) one or more configuration files to configuration analysis platform 336 on their own volition, for example, on a predetermined schedule and/or in response to one or more predetermined events (e.g., a change in one or more of their respective configuration files).

At step 7, configuration analysis platform 336 may analyze the received configuration files (e.g., the configuration files received from one or more of servers 308, 310, 312, 314, 316, 318, 320, 322, 324, 326, 328, and 330). As indicated above, each of the received configuration files may comprise a plurality of attribute types (e.g., “ServerRoot,” “PidFile,” “Timeout,” “KeepAlive,” “MaxKeepAliveRequests,” and the like) and a plurality of attribute values (e.g., “/host/configs/Server$123,” “host/logs/$456/httpd.pid,” “300,” “On,” “500,” and the like). Each of the plurality of attribute values may correspond to one or more of the plurality of attribute types (e.g., “ServerRoot” may correspond to “/host/configs/Server$123,” “PidFile” may correspond to “host/logs/$456/httpd.pid,” “Timeout” may correspond to “300,” “KeepAlive” may correspond to “On,” “MaxKeepAliveRequests” may correspond to “500,” and the like). Analyzing the received configuration files may include generating a dynamic benchmark configuration file. The dynamic benchmark configuration file may comprise each of the plurality of attribute types (e.g., “ServerRoot,” “PidFile,” “Timeout,” “KeepAlive,” “MaxKeepAliveRequests,” and the like) and a benchmark attribute value corresponding to each attribute type of the plurality of attribute types (e.g., “/host/configs/Server$123,” “host/logs/$456/httpd.pid,” “300,” “On,” “500,” and the like). The benchmark attribute value may comprise an attribute value equivalent to an attribute value of a majority of the plurality of attribute values that correspond to the attribute type (e.g., “/host/configs/Server$123,” “host/logs/$456/httpd.pid,” “300,” “On,” “500,” and the like may be associated with their respective attribute types for a majority of the configuration files received from servers 308, 310, 312, 314, 316, 318, 320, 322, 324, 326, 328, and 330, or one or more identified portions thereof (e.g., servers 308, 310, 312, and 314, associated with computing environment 302; servers 316, 318, 320, and 322, associated with computing environment 304; and/or servers 324, 326, 328, and 330, associated with computing environment 306)).

In some embodiments, configuration analysis platform 336 may be configured to generate the dynamic benchmark configuration file by comparing each configuration file of the plurality of configuration files (e.g., the configuration files received from servers 308, 310, 312, 314, 316, 318, 320, 322, 324, 326, 328, and 330) to each other configuration file of the plurality of configuration files. Comparing each configuration file of the plurality of configuration files to each other configuration file of the plurality of configuration files may include, for each attribute type of the plurality of attribute types (e.g., “ServerRoot,” “PidFile,” “Timeout,” “KeepAlive,” “MaxKeepAliveRequests,” and the like), comparing one or more attribute values of the plurality of attribute values (e.g., “/host/configs/Server$123,” “host/logs/$456/httpd.pid,” “300,” “On,” “500,” and the like) of the configuration file that correspond to the attribute type to one or more attribute values of the plurality of attribute values of the other configuration file that correspond to the attribute type. Each configuration file of the plurality of configuration files may then be compared to the dynamic benchmark configuration file. For example, each of the configuration files received from servers 308, 310, 312, 314, 316, 318, 320, 322, 324, 326, 328, and 330 may be compared to the generated dynamic benchmark configuration file (e.g., a file comprising attribute values equivalent to an attribute value of a majority of the plurality of attribute values that correspond to the attribute type (e.g., “/host/configs/Server$123,” “host/logs/$456/httpd.pid,” “300,” “On,” “500,” and the like may be associated with their respective attribute types for a majority of the configuration files received from servers 308, 310, 312, 314, 316, 318, 320, 322, 324, 326, 328, and 330, or one or more identified portions thereof (e.g., servers 308, 310, 312, and 314, associated with computing environment 302; servers 316, 318, 320, and 322, associated with computing environment 304; and/or servers 324, 326, 328, and 330, associated with computing environment 306)).

In some embodiments, each attribute type of a received configuration file having one or more attribute values that differ from one or more attribute values of a corresponding attribute type of the dynamic benchmark configuration file may be identified. For example, a configuration file received from server 310 may include an attribute value of “5” corresponding to attribute type “KeepAliveTimeout,” the dynamic benchmark configuration file may include an attribute value of “10” corresponding to the attribute type “KeepAliveTimeout” (e.g., the attribute value “10” may be associated with the attribute type “KeepAliveTimeout” for a majority of the configuration files received from servers 308, 310, 312, 314, 316, 318, 320, 322, 324, 326, 328, and 330, or one or more identified portions thereof (e.g., servers 308, 310, 312, and 314, associated with computing environment 302) and analyzing the configuration files received from servers 308, 310, 312, 314, 316, 318, 320, 322, 324, 326, 328, and 330 may include identifying the attribute type “KeepAliveTimeout” of the configuration file received from server 310 as having an attribute value (e.g., “5”) that differs from an attribute value of the dynamic benchmark configuration file corresponding to the attribute type “KeepAliveTimeout” (e.g., “10”).

Configuration analysis platform 336 may be configured to determine that a received configuration file includes one or more attribute values that differ from one or more attribute values of a corresponding attribute type of the dynamic benchmark configuration file by comparing each configuration file of the plurality of configuration files to the dynamic benchmark configuration file. For example, configuration analysis platform 336 may be configured to, for each attribute type of the plurality of attribute types included in the configuration files received from servers 308, 310, 312, 314, 316, 318, 320, 322, 324, 326, 328, and 330 (e.g., “ServerRoot,” “PidFile,” “Timeout,” “KeepAlive,” “MaxKeepAliveRequests,” and the like), compare one or more attribute values of the plurality of attribute values of the configuration file that correspond to the attribute type to one or more attribute values of the plurality of attribute values of the dynamic benchmark configuration file that correspond to the attribute type (e.g., compare an attribute value of the attribute type “ServerRoot” of a received configuration file to an attribute value of the attribute type “ServerRoot” of the generated dynamic benchmark configuration file, compare an attribute value of the attribute type “PidFile” of a received configuration file to an attribute value of the attribute type “PidFile” of the generated dynamic benchmark configuration file, compare an attribute value of the attribute type “Timeout” of a received configuration file to an attribute value of the attribute type “Timeout” of the generated dynamic benchmark configuration file, compare an attribute value of the attribute type “KeepAlive” of a received configuration file to an attribute value of the attribute type “KeepAlive” of the generated dynamic benchmark configuration file, compare an attribute value of the attribute type “MaxKeepAliveRequests” of a received configuration file to an attribute value of the attribute type “MaxKeepAliveRequests” of the generated dynamic benchmark configuration file, and so on).

In some embodiments, prior to comparing each configuration file of the plurality of configuration files to the dynamic benchmark configuration file, configuration analysis platform 336 may be configured to identify a plurality of token attribute types of the plurality of attribute types. Each of the plurality of token attribute types may correspond to an attribute type of the plurality of attribute types whose corresponding attribute value is expected to differ from a corresponding attribute value of one or more other of the plurality of configuration files (e.g., “CellCode,” “PidFileInstanceId,” “HostName,” “IPAddress,” or the like). For each identified token attribute type of the plurality of token attribute types, an attribute value (e.g., “123,” “456,” “samplehost.sampledomain.com,” “1.2.3.4,” or the like) corresponding to the token attribute type may be replaced with a common token attribute value, for example, a predetermined text string corresponding to the token attribute type (e.g., “CELLCODE,” “INSTANCE,” “HOSTNAME,” “IPADDRESS,” or the like) for each of the plurality of configuration files. For each identified token attribute type (e.g., “CellCode”), configuration analysis platform 336 may compare an attribute value of the configuration file comprising the common token attribute value (e.g., “CELLCODE”) to an attribute value of the dynamic benchmark configuration file comprising the common token attribute value (e.g., “CELLCODE”). Configuration analysis platform 336 may therefore not identify the underlying attribute value of the configuration file (e.g., “123”) as differing from any possible corresponding underlying attribute value of the dynamic benchmark configuration file. For example, the dynamic benchmark configuration file may not include an actual underlying attribute value associated with the attribute type “CellCode” because there may not be a majority of the configuration files received from servers 308, 310, 312, 314, 316, 318, 320, 322, 324, 326, 328, and 330 that include the same underlying attribute value associated with the attribute type “CellCode” (e.g., because such an attribute value may be expected to be unique).

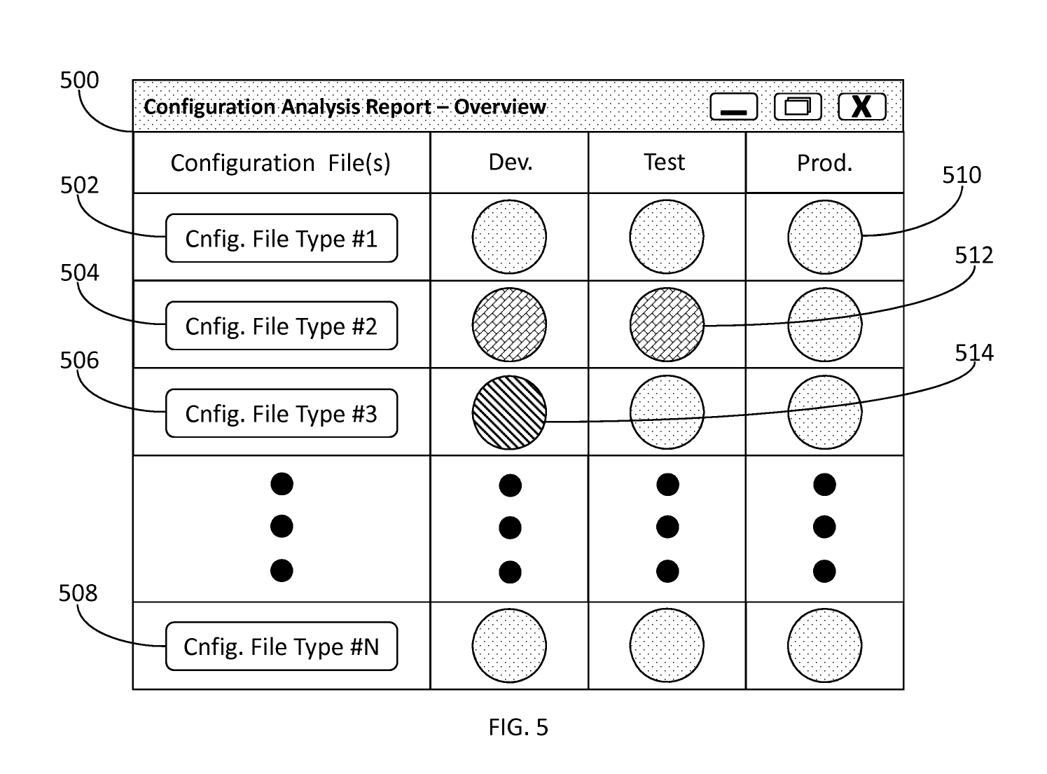

At step 8, configuration analysis platform 336 may generate a report based on the analyzed configuration files. For example, configuration analysis platform 336 may generate a configuration analysis report UI similar to that depicted in FIG. 5. Referring to FIG. 5, user interface 500 may include a listing of one or more types of configuration files of at least a portion of the plurality of configuration files received from servers 308, 310, 312, 314, 316, 318, 320, 322, 324, 326, 328, and 330. For example, configuration analysis platform may identify from among the configuration files received from servers 308, 310, 312, 314, 316, 318, 320, 322, 324, 326, 328, and 330 one or more types of configuration files (e.g., configuration file types 502, 504, 506, and 508), for example, based on one or more common attribute types shared by the one or more configuration files. User interface 500 may also include a listing of one or more computing environments (e.g., computing environments 302, 304, and 306).

User interface 500 may further include, for each combination of a configuration file type listed within the listing of the one or more types of configuration files and an environment listed within the listing of the one or more computing environments, an indication of whether a plurality of configuration files of the configuration file type that correspond to one or more servers of the plurality of servers that are associated with the environment have one or more corresponding attribute types comprising differing attribute values. For example, for file type 502 and computing environment 306, user interface 500 may include indication 510. Similarly, for file type 504 and computing environment 304, user interface 500 may include indication 512; and for file type 506 and computing environment 302, user interface 500 may include indication 514. In some embodiments, one or more of the indications may comprise one or more visual indicators (e.g., gradients, colors, or the like) indicating whether a plurality of configuration files of the configuration file type that correspond to one or more servers of the plurality of servers that are associated with the environment have one or more corresponding attribute types comprising differing attribute values and/or whether the existence of such differing attribute values has been determined to be acceptable. For example, indication 510 may indicate (e.g., by being colored green) that configuration files of configuration file type 502 associated with computing environment 306 do not have one or more corresponding attribute types comprising differing attribute values; indication 512 may indicate (e.g., by being colored yellow) that configuration files of configuration file type 504 associated with computing environment 304 do have one or more corresponding attribute types comprising differing attribute values, but that the existence of such differing attribute values has been determined to be acceptable (e.g., related to testing of a new update); and indication 514 may indicate (e.g., by being colored red) that configuration files of configuration file type 506 associated with computing environment 302 do have one or more corresponding attribute types comprising differing attribute values, and that the existence of such differing attribute values has not been determined to be acceptable (e.g., further inquiry into such differing attribute values may be warranted). Returning to FIG. 4, at step 9, the report generated based on the analyzed configuration files (e.g., a configuration analysis report UI similar to that depicted in FIG. 5) may be communicated to user device 334 (e.g., for display to one or more users).

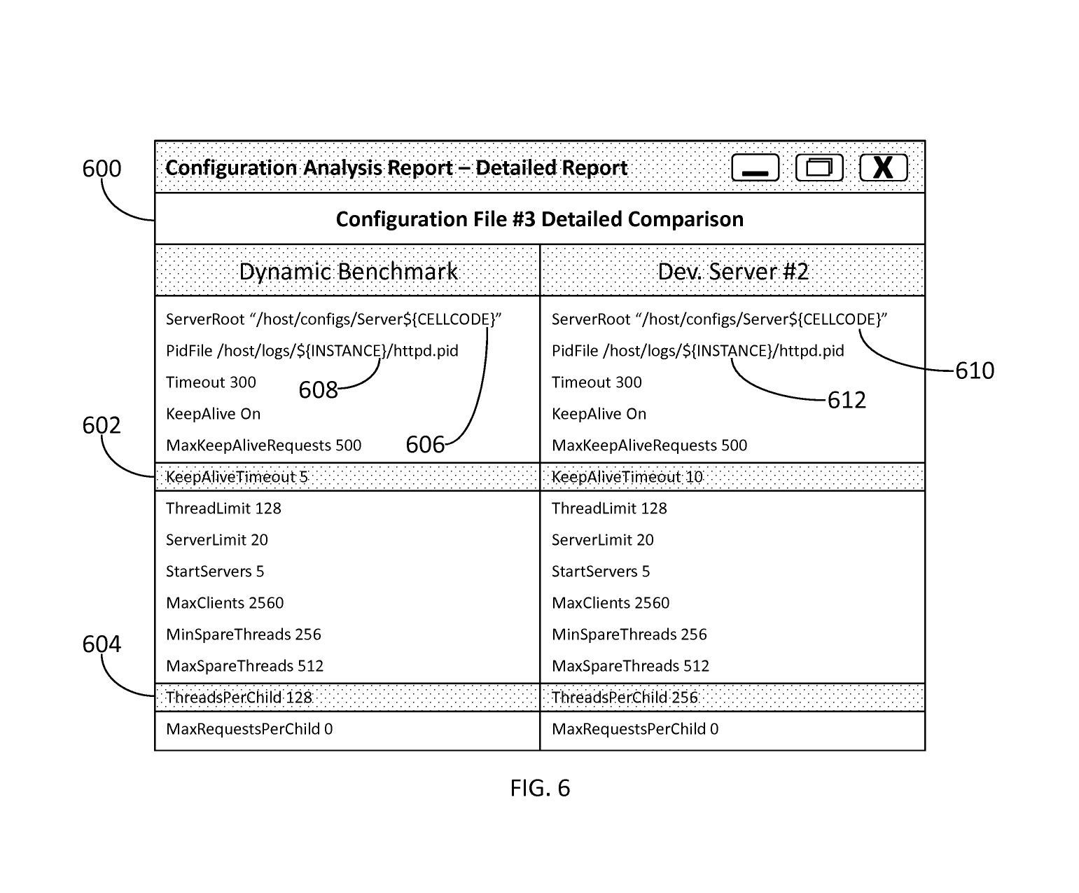

A user may select a combination of a configuration file type listed within the listing of the one or more types of configuration files and an environment listed within the listing of the one or more computing environments. For example, a user of user device 334 may select a combination of file type 506 and computing environment 302 (e.g., by selecting indication 514). Responsive to the selection of the combination of the configuration file type and the environment, a second user interface may be generated. For example, responsive to a user of user device 314 selecting the combination of file type 506 and computing environment 302, configuration analysis platform 336 may generate a configuration analysis report UI similar to that depicted in FIG. 6. Referring to FIG. 6, user interface 600 may include a side-by-side comparison of at least one configuration file of the plurality of configuration files (e.g., a configuration file of file type 506 received from computing environment 302) and a dynamic benchmark configuration file (e.g., a dynamic benchmark configuration file corresponding to file type 506).

In some embodiments, the side-by-side comparison of the at least one configuration file and the dynamic benchmark configuration file may include at least one visual indication of one or more corresponding attribute types comprising differing attribute values. For example, user interface 600 may include visual indications 602 and 604 respectively corresponding to attribute types “KeepAliveTimeout” and “ThreadsPerChild” for which the attribute values of the configuration file type of file type 506 received from computing environment 302 and the dynamic benchmark configuration file corresponding to file type 506 have one or more differing attribute values (e.g., “5” versus “10” and “128” versus “256”). Additionally or alternatively, the side-by-side comparison of the at least one configuration file and the dynamic benchmark configuration file may include at least one visual indication that a common token attribute value of the at least one configuration file was compared with a common token attribute value of the dynamic benchmark configuration file. For example, user interface 600 may include visual indications 606 and 608 respectively corresponding to attribute types “ServerRoot” and “PidFile” for which the attribute values of the configuration file of file type 506 received from computing environment 302 and corresponding to attribute types “ServerRoot” and “PidFile” were replaced with a common token attribute value (e.g., “{CELLCODE}” and “{INSTANCE}”). Similarly, user interface 600 may include visual indications 610 and 612 respectively corresponding to attribute types “ServerRoot” and “PidFile” for which any attribute values of the dynamic benchmark configuration file of file type 506 corresponding to attribute types “ServerRoot” and “PidFile” were replaced with a common token attribute value (e.g., “{CELLCODE}” and “{INSTANCE}”).

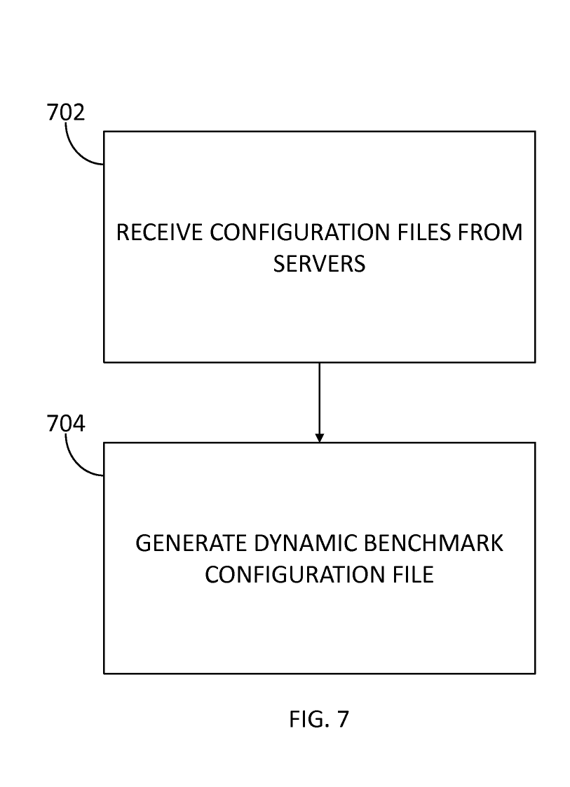

FIG. 7 depicts an illustrative method for dynamic configuration analysis in accordance with one or more example embodiments. Referring to FIG. 7, at step 702 a plurality of configuration files may be received from a plurality of servers. For example, configuration analysis platform 336 may receive a plurality of configuration files from a plurality of servers (e.g., servers 308, 310, 312, 314, 316, 318, 320, 322, 324, 326, 328, and 330). Each configuration file of the plurality of configuration files may comprise a plurality of attribute types (e.g., “ServerRoot,” “PidFile,” “Timeout,” “KeepAlive,” “MaxKeepAliveRequests,” and the like) and a plurality of attribute values (e.g., “/host/configs/Server$123,” “host/logs/$456/httpd.pid,” “300,” “On,” “500,” and the like). Each of the plurality of attribute values may correspond to one or more of the plurality of attribute types (e.g., “ServerRoot” may correspond to “/host/configs/Server$123,” “PidFile” may correspond to “host/logs/$456/httpd.pid,” “Timeout” may correspond to “300,” “KeepAlive” may correspond to “On,” “MaxKeepAliveRequests” may correspond to “500,” and the like). At step 704, a dynamic benchmark configuration file may be generated. The dynamic benchmark configuration file may comprise each of the plurality of attribute types (e.g., “ServerRoot,” “PidFile,” “Timeout,” “KeepAlive,” “MaxKeepAliveRequests,” and the like) and a benchmark attribute value corresponding to each attribute type of the plurality of attribute types (e.g., “/host/configs/Server$123,” “host/logs/$456/httpd.pid,” “300,” “On,” “500,” and the like). The benchmark attribute value may comprise an attribute value equivalent to an attribute value of a majority of the plurality of attribute values that correspond to the attribute type (e.g., “/host/configs/Server$123,” “host/logs/$456/httpd.pid,” “300,” “On,” “500,” and the like may be associated with their respective attribute types for a majority of the configuration files received from servers 308, 310, 312, 314, 316, 318, 320, 322, 324, 326, 328, and 330, or one or more identified portions thereof (e.g., servers 308, 310, 312, and 314, associated with computing environment 302; servers 316, 318, 320, and 322, associated with computing environment 304; and/or servers 324, 326, 328, and 330, associated with computing environment 306)).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a computing platform comprising at least one processor, a memory, and a communication interface:
receiving, via the communication interface and from a plurality of servers, a plurality of configuration files, each configuration file of said plurality of configuration files comprising a plurality of attribute types and a plurality of attribute values, each of the plurality of attribute values corresponding to one or more of the plurality of attribute types; and
generating, by the at least one processor, a dynamic benchmark configuration file, said dynamic benchmark configuration file comprising each of the plurality of attribute types and a benchmark attribute value corresponding to each attribute type of the plurality of attribute types, said benchmark attribute value comprising an attribute value equivalent to an attribute value of a majority of the plurality of attribute values that correspond to the attribute type.

2. The method of claim 1, wherein generating the dynamic benchmark configuration file comprises comparing each configuration file of the plurality of configuration files to each other configuration file of the plurality of configuration files, and wherein comparing each configuration file of the plurality of configuration files to each other configuration file of the plurality of configuration files comprises, for each attribute type of the plurality of attribute types, comparing one or more attribute values of the plurality of attribute values of the configuration file that correspond to the attribute type to one or more attribute values of the plurality of attribute values of the other configuration file that correspond to the attribute type.

3. The method of claim 1, comprising:
comparing each configuration file of the plurality of configuration files to the dynamic benchmark configuration file; and
identifying each attribute type of the configuration file having one or more attribute values that differ from one or more attribute values of a corresponding attribute type of the dynamic benchmark configuration file.

4. The method of claim 3, wherein comparing each configuration file of the plurality of configuration files to the dynamic benchmark configuration file comprises, for each attribute type of the plurality of attribute types, comparing one or more attribute values of the plurality of attribute values of the configuration file that correspond to the attribute type to one or more attribute values of the plurality of attribute values of the dynamic benchmark configuration file that correspond to the attribute type.

5. The method of claim 4, comprising:
prior to comparing each configuration file of the plurality of configuration files to the dynamic benchmark configuration file:
identifying a plurality of token attribute types of the plurality of attribute types, wherein each of the plurality of token attribute types corresponds to an attribute type of the plurality of attribute types whose corresponding attribute value is expected to differ from a corresponding attribute value of one or more other of the plurality of configuration files; and
for each identified token attribute type of the plurality of token attribute types, replacing an attribute value corresponding to the token attribute type with a common token attribute value for each of the plurality of configuration files.

6. The method of claim 5, wherein comparing one or more attribute values of the plurality of attribute values of the configuration file that correspond to the attribute type to one or more attribute values of the plurality of attribute values of the dynamic benchmark configuration file that correspond to the attribute type comprises, for each identified token attribute type of the plurality of token attribute types, comparing an attribute value of the configuration file comprising the common token attribute value to an attribute value of the dynamic benchmark configuration file comprising the common token attribute value.

7. The method of claim 1, comprising generating a user interface, said user interface comprising:
a listing of one or more types of configuration files of at least a portion of the plurality of configuration files;
a listing of one or more computing environments; and
for each combination of a configuration file type listed within the listing of the one or more types of configuration files and an environment listed within the listing of the one or more computing environments, an indication of whether a plurality of configuration files of the configuration file type that correspond to one or more servers of the plurality of servers that are associated with the environment have one or more corresponding attribute types comprising differing attribute values.

8. The method of claim 7, comprising, responsive to a selection of a combination of a configuration file type listed within the listing of the one or more types of configuration files and an environment listed within the listing of the one or more computing environments, generating a second user interface, said second user interface comprising a side-by-side comparison of at least one configuration file of the plurality of configuration files and the dynamic benchmark configuration file, the at least one configuration file and the dynamic benchmark configuration file being of the configuration file type, and the at least one configuration file corresponding to one or more servers of the plurality of servers that are associated with the environment.

9. The method of claim 8, wherein the side-by-side comparison of the at least one configuration file and the dynamic benchmark configuration file comprises at least one visual indication of one or more corresponding attribute types comprising differing attribute values.

10. The method of claim 8, wherein the side-by-side comparison of the at least one configuration file and the dynamic benchmark configuration file comprises at least one visual indication indicating that a common token attribute value of the at least one configuration file was compared with a common token attribute value of the dynamic benchmark configuration file.

11. An apparatus, comprising:
at least one processor; and
a memory storing instructions that when executed by the at least one processor cause the apparatus to:
receive, from a plurality of servers, a plurality of configuration files, each configuration file of said plurality of configuration files comprising a plurality of attribute types and a plurality of attribute values, each of the plurality of attribute values corresponding to one or more of the plurality of attribute types;
compare each configuration file of the plurality of configuration files to each other configuration file of the plurality of configuration files; and
generate a dynamic benchmark configuration file, said dynamic benchmark configuration file comprising each of the plurality of attribute types and a benchmark attribute value corresponding to each attribute type of the plurality of attribute types, said benchmark attribute value comprising an attribute value equivalent to an attribute value of a majority of the plurality of attribute values that correspond to the attribute type

12. The apparatus of claim 11, wherein the instructions when executed by the at least one processor cause the apparatus to:
compare each configuration file of the plurality of configuration files to the dynamic benchmark configuration file; and
identify each attribute type of the configuration file having one or more attribute values that differ from one or more attribute values of a corresponding attribute type of the dynamic benchmark configuration file.

13. The apparatus of claim 12, wherein the instructions when executed by the at least one processor cause the apparatus to, for each attribute type of the plurality of attribute types, compare one or more attribute values of the plurality of attribute values of the configuration file that correspond to the attribute type to one or more attribute values of the plurality of attribute values of the dynamic benchmark configuration file that correspond to the attribute type.

14. The apparatus of claim 13, wherein the instructions when executed by the at least one processor cause the apparatus to:
identify a plurality of token attribute types of the plurality of attribute types, wherein each of the plurality of token attribute types corresponds to an attribute type of the plurality of attribute types whose corresponding attribute value is expected to differ from a corresponding attribute value of one or more other of the plurality of configuration files; and
for each identified token attribute type of the plurality of token attribute types, replace an attribute value corresponding to the token attribute type with a common token attribute value for each of the plurality of configuration files.

15. The apparatus of claim 14, wherein the instructions when executed by the at least one processor cause the apparatus to, for each identified token attribute type of the plurality of token attribute types, compare an attribute value of the configuration file comprising the common token attribute value to an attribute value of the dynamic benchmark configuration file comprising the common token attribute value.

16. One or more non-transitory computer-readable media having instructions stored thereon, that when executed by one or more computers, cause the one or more computers to:
receive, from a plurality of servers, a plurality of configuration files, each configuration file of said plurality of configuration files comprising a plurality of attribute types and a plurality of attribute values, each of the plurality of attribute values corresponding to one or more of the plurality of attribute types;
generate a dynamic benchmark configuration file, said dynamic benchmark configuration file comprising each of the plurality of attribute types and a benchmark attribute value corresponding to each attribute type of the plurality of attribute types, said benchmark attribute value comprising an attribute value equivalent to an attribute value of a majority of the plurality of attribute values that correspond to the attribute type;
compare each configuration file of the plurality of configuration files to the dynamic benchmark configuration file; and
identify each attribute type of the configuration file having one or more attribute values that differ from one or more attribute values of a corresponding attribute type of the dynamic benchmark configuration file.

17. The one or more non-transitory computer-readable media of claim 16, wherein the instructions, when executed by the one or more computers, cause the one or more computers to generate a user interface, said user interface comprising:
a listing of one or more types of configuration files of at least a portion of the plurality of configuration files;
a listing of one or more computing environments; and
for each combination of a configuration file type listed within the listing of the one or more types of configuration files and an environment listed within the listing of the one or more computing environments, an indication of whether a plurality of configuration files of the configuration file type that correspond to one or more servers of the plurality of servers that are associated with the environment have one or more corresponding attribute types comprising differing attribute values.

18. The one or more non-transitory computer-readable media of claim 17, wherein the instructions, when executed by the one or more computers, cause the one or more computers to, responsive to a selection of a combination of a configuration file type listed within the listing of the one or more types of configuration files and an environment listed within the listing of the one or more computing environments, generate a second user interface, said second user interface comprising a side-by-side comparison of at least one configuration file of the plurality of configuration files and the dynamic benchmark configuration file, the at least one configuration file and the dynamic benchmark configuration file being of the configuration file type, and the at least one configuration file corresponding to one or more servers of the plurality of servers that are associated with the environment.

19. The one or more non-transitory computer-readable media of claim 18, wherein the side-by-side comparison of the at least one configuration file and the dynamic benchmark configuration file comprises at least one visual indication of one or more corresponding attribute types comprising differing attribute values.

20. The one or more non-transitory computer-readable media of claim 18, wherein the side-by-side comparison of the at least one configuration file and the dynamic benchmark configuration file comprises at least one visual indication indicating that a common token attribute value of the at least one configuration file was compared with a common token attribute value of the dynamic benchmark configuration file.
